(19) United States
(12) Patent Application Publication
(10) Pub. No.: US 2012/0094613 A1
(43) Pub. Date: Apr. 19, 2012

(54) TEMPERATURE DEPENDENT VOLTAGE REGULATOR

(75) Inventors: Kai Zhong, Gilbert, AZ (US); Pengbei Zhang, Chandler, AZ (US)

(73) Assignee: FUJITSU SEMICONDUCTOR LIMITED, Kanagawa (JP)

(21) Appl. No.: 12/905,241

(22) Filed: Oct. 15, 2010

(51) Int. Cl. H04B 1/38; G05F 1/10

(52) U.S. Cl. 455/73; 323/273

(57) ABSTRACT

Systems and methods for reducing power consumption of a voltage regulator are disclosed. In accordance with one embodiment of the present disclosure a voltage regulator comprises an input node configured to receive a reference voltage and an output node configured to output an output voltage. The output voltage is a function of the reference voltage and a regulating current. The regulator further comprises a proportional to absolute temperature (PTAT) circuit coupled to at least one of the output node and the input node. The PTAT circuit is configured to vary at least one of the reference voltage and the regulating current as a function of temperature.

### TECHNICAL FIELD

The present disclosure relates generally to voltage regulators and, more particularly, to a temperature dependent voltage regulator.

### BACKGROUND

Electronic devices are constantly being improved to have more capability and increased performance. Portable electronic devices, especially in the telecommunications industry, are among one of the fastest growing and innovative segments of the electronics industry. The demands in this market include low cost, long battery life, small size, increased performance, and increased capabilities of these devices.

Electronic devices typically utilize voltage regulators to provide the appropriate amount of power to the various circuits included within them. The increased performance requirements and capabilities of the electronic devices, especially in portable electronic devices, also require an increase in the performance capabilities of the voltage regulators included within the devices. One such performance requirement is reduced power consumption.

### SUMMARY

In accordance with the teachings of the present disclosure, the disadvantages and problems associated with reducing power consumption of voltage regulators may be reduced.

In accordance with one embodiment of the present disclosure a voltage regulator comprises an input node configured to receive a reference voltage and an output node configured to output an output voltage. The output voltage is a function of the reference voltage and a regulating current. The regulator further comprises a proportional to absolute temperature (PTAT) circuit coupled to at least one of the output node and the input node. The PTAT circuit is configured to vary at least one of the reference voltage and the regulating current as a function of temperature.

Other technical advantages will be apparent to those of ordinary skill in the art in view of the following specification, claims, and drawings.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of an example wireless communication system, in accordance with certain embodiments of the present disclosure;

FIG. 2 illustrates an example block diagram of selected components of a transmitting and/or receiving element, in accordance with certain embodiments of the present disclosure;

FIG. 3 illustrates an example schematic of a regulator configured to have a temperature dependent output voltage, in accordance with certain embodiments of the present disclosure;

FIG. 4 illustrates another example schematic of a regulator configured to have a temperature dependent output voltage, in accordance with certain embodiments of the present disclosure;

FIG. 5 illustrates a further example schematic of a regulator configured to have a temperature dependent output voltage, in accordance with certain embodiments of the present disclosure;

FIG. 6 illustrates an additional example schematic of a regulator configured to have a temperature dependent output voltage, in accordance with certain embodiments of the present disclosure; and

FIG. 7 illustrates an example method for regulating the output voltage of a voltage regulator based on temperature, in accordance with certain embodiments of the present disclosure.

### DETAILED DESCRIPTION

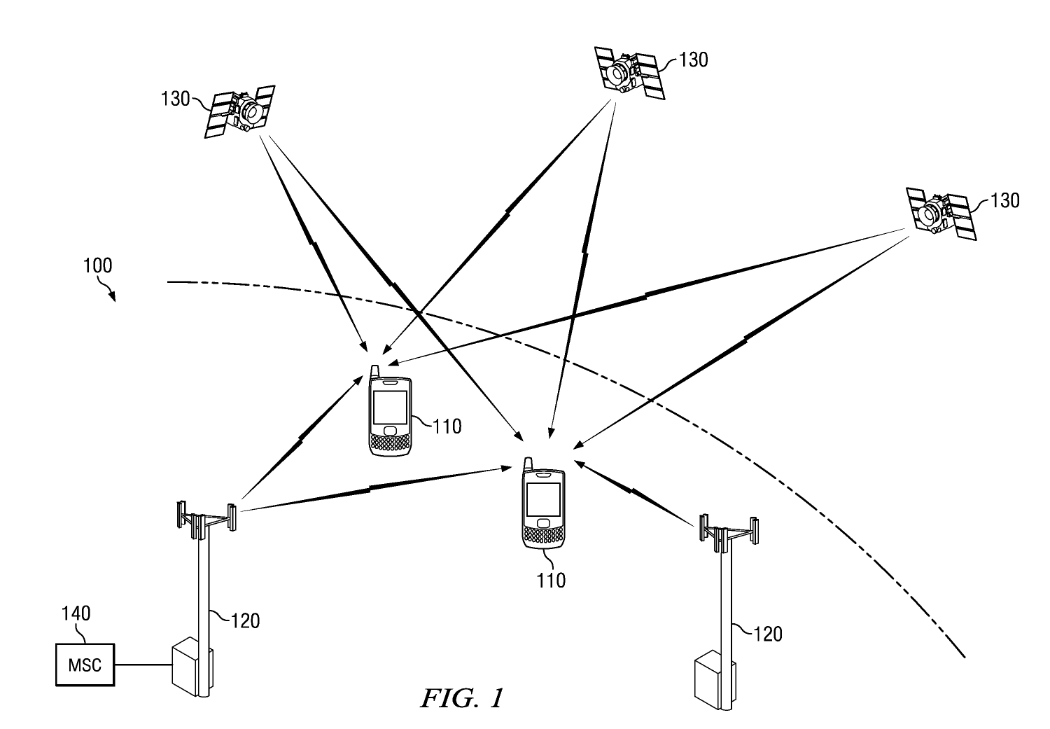

The wireless telecommunications industry is an industry that requires electronic devices—especially portable electronic devices, such as cellular phones—to have increased performance requirements and capabilities that may also require an increase in voltage regulator performance capabilities. FIG. 1 illustrates a block diagram of an example wireless communication system 100, in accordance with certain embodiments of the present disclosure. For simplicity, only two terminals 110 and two base stations 120 are shown in FIG. 1. A terminal 110 may also be referred to as a remote station, a mobile station, an access terminal, user equipment (UE), a wireless communication device, a cellular phone, or some other terminology.

A base station 120 may be a fixed station and may also be referred to as an access point, a Node B, or some other terminology. A mobile switching center (MSC) 140 may be coupled to the base stations 120 and may provide coordination and control for base stations 120.

A terminal 110 may or may not be capable of receiving signals from satellites 130. Satellites 130 may belong to a satellite positioning system such as the well-known Global Positioning System (GPS). Each GPS satellite may transmit a GPS signal encoded with information that allows GPS receivers on earth to measure the time of arrival of the GPS signal. Measurements for a sufficient number of GPS satellites may be used to accurately estimate a three-dimensional position of a GPS receiver. A terminal 110 may also be capable of receiving signals from other types of transmitting sources such as a Bluetooth transmitter, a Wireless Fidelity (Wi-Fi) transmitter, a wireless local area network (WLAN) transmitter, an IEEE 802.11 transmitter, and any other suitable transmitter.

In FIG. 1, each terminal 110 is shown as receiving signals from multiple transmitting sources simultaneously, where a transmitting source may be a base station 120 or a satellite 130. In certain embodiments, a terminal 110 may also be a transmitting source. In general, a terminal 110 may receive signals from zero, one, or multiple transmitting sources at any given moment.

System 100 may be a Code Division Multiple Access (CDMA) system, a Time Division Multiple Access (TDMA) system, or some other wireless communication system. A CDMA system may implement one or more CDMA standards such as IS-95, IS-2000 (also commonly known as “1x”), IS-856 (also commonly known as “1xEV-DO”), Wideband-CDMA (W-CDMA), and so on. A TDMA system may implement one or more TDMA standards such as Global System for Mobile Communications (GSM). The W-CDMA standard is defined by a consortium known as 3GPP, and the IS-2000 and IS-856 standards are defined by a consortium known as 3GPP2.

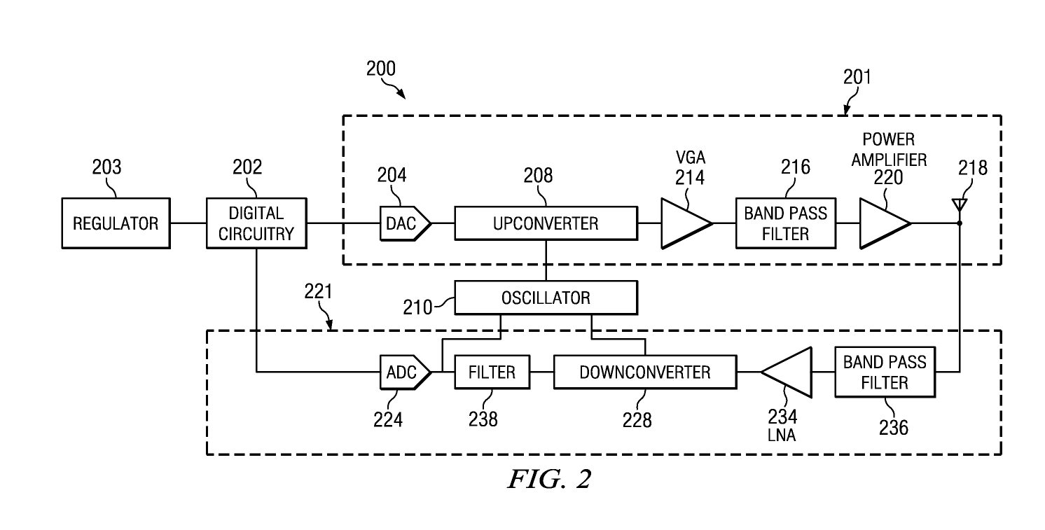

FIG. 2 illustrates a block diagram of selected components of an example transmitting and/or receiving element 200 (e.g., a terminal 110, a base station 120, or a satellite 130), in accordance with certain embodiments of the present disclosure. Element 200 may include a transmit path 201 and/or a receive path 221. Depending on the functionality of element 200, element 200 may be considered a transmitter, a receiver, or a transceiver.

Transmitting source 200 may include one or more voltage regulators 203. Voltage regulator 203 may comprise any system, apparatus or device configured to regulate the voltage supplied to one or more of the various circuits and components included in transmitting source 200. In some instances, voltage regulators 203 may comprise a low dropout (LDO) linear regulator. In the present example, voltage regulator 203 is depicted as providing power to digital circuitry 202. However, it is understood that transmitting source 200 may include other regulators configured to provide power to other components of transmitting source 200.

Digital circuitry 202 may include any system, device, or apparatus configured to process digital signals and information received via receive path 221, and/or configured to process signals and information for transmission via transmit path 201. Such digital circuitry 202 may include one or more microprocessors, digital signal processors, and/or other suitable devices.

Transmit path 201 may include a digital-to-analog converter (DAC) 204. DAC 204 may be configured to receive a digital signal from digital circuitry 202 and convert such digital signal into an analog signal. Such analog signal may then be passed to one or more other components of transmit path 201, including upconverter 208.

Upconverter 208 may be configured to frequency upconvert an analog signal received from DAC 204 to a wireless communication signal at a radio frequency based on an oscillator signal provided by oscillator 210. Oscillator 210 may be any suitable device, system, or apparatus configured to produce an analog waveform of a particular frequency for modulation or upconversion of an analog signal to a wireless communication signal, or for demodulation or downconversion of a wireless communication signal to an analog signal. In some embodiments, oscillator 210 may be a digitally-controlled crystal oscillator.

Transmit path 201 may include a variable-gain amplifier (VGA) 214 to amplify an upconverted signal for transmission, and a bandpass filter 216 configured to receive an amplified signal VGA 214 and pass signal components in the band of interest and remove out-of-band noise and undesired signals. The bandpass filtered signal may be received by power amplifier 220 where it is amplified for transmission via antenna 218. Antenna 218 may receive the amplified and transmit such signal (e.g., to one or more of a terminal 110, a base station 120, and/or a satellite 130).

Receive path 221 may include a bandpass filter 236 configured to receive a wireless communication signal (e.g., from a terminal 110, a base station 120, and/or a satellite 130) via antenna 218. Bandpass filter 236 may pass signal components in the band of interest and remove out-of-band noise and undesired signals. In addition, receive path 221 may include a low-noise amplifiers (LNA) 224 to amplify a signal received from bandpass filter 236.

Receive path 221 may also include a downconverter 228. Downconverter 228 may be configured to frequency downconvert a wireless communication signal received via antenna 218 and amplified by LNA 234 by an oscillator signal provided by oscillator 210 (e.g., downconvert to a baseband signal).

Receive path 221 may further include a filter 238, which may be configured to filter a downconverted wireless communication signal in order to pass the signal components within a radio-frequency channel of interest and/or to remove noise and undesired signals that may be generated by the downconversion process. In addition, receive path 221 may include an analog-to-digital converter (ADC) 224 configured to receive an analog signal from filter 238 and convert such analog signal into a digital signal. Such digital signal may then be passed to digital circuitry 202 for processing.

As mentioned earlier, transmitting source 200 may comprise a wireless device powered by a battery. Some of the circuitry included in transmitting source 200 may require a higher voltage at higher temperatures and a lower voltage at lower temperatures for proper operation. Accordingly, regulator 203 may comprise a temperature dependent voltage regulator. A temperature dependent voltage regulator may be advantageous by providing higher voltage to the temperature dependent circuitry at higher temperatures and by providing lower voltage to the temperature dependent circuitry at lower temperatures.

A temperature dependent voltage regulator may reduce power consumption and increase battery life of a transmitting source 200 compared to a conventional voltage regulator. A conventional voltage regulator may be configured to constantly operate at a high voltage associated with the voltage requirements of the temperature dependent circuitry to meet worst case scenario design specifications. However, by constantly operating at the higher voltage level, even when the circuitry powered by the regulator may function properly at a lower voltage—due to the circuitry operating in a lower temperature environment—the circuitry may consume more power than necessary. Accordingly, a temperature dependent voltage regulator may ensure that the temperature dependent circuitry is powered at the proper voltage level at high temperatures. Additionally, the temperature dependent regulator may lower its output voltage at lower temperatures such that the temperature dependent regulator may provide the temperature dependent circuitry with adequate voltage but also may reduce power consumption.

Modifications, additions or omissions may be made to FIG. 2 without departing from the scope of the present disclosure. For example, transmitting source 200 is depicted as including only one regulator 203 coupled to and providing power to digital circuitry 202. However, regulator 203 may be coupled to other components of transmitting source 200 (e.g., components included in transmit path 201, oscillator 210, and components included in receive path 221, etc.). Additionally, transmitting source 200 may include a plurality of regulators 203 coupled to one or more of the components of transmitting source 200.

Further, regulator 203 has been described with respect to being used in a telecommunications device. However, the utilization of a temperature dependent regulator, such as regulator 203 should not be limited to such. A temperature dependent regulator may be used with respect to any suitable system, apparatus or device where varying the voltage output by temperature may prove to be useful.

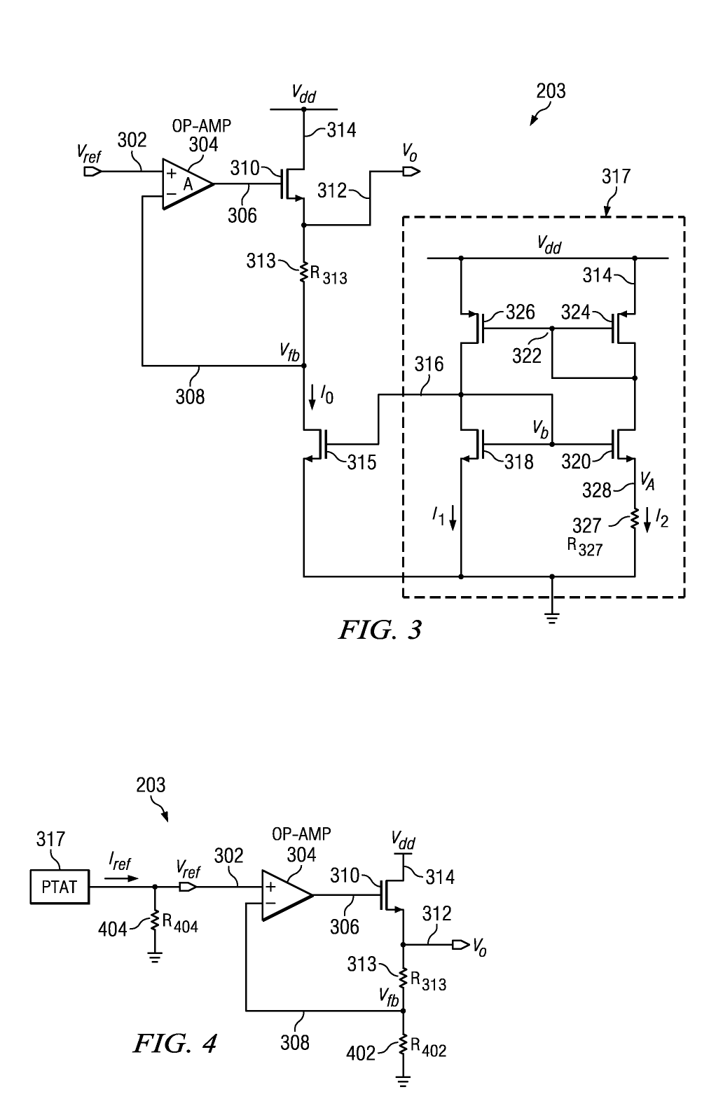

FIG. 3 illustrates an example schematic of a temperature dependent voltage regulator 203. In the present example, regulator 203 may include a low drop-out (LDO) regulator. Regulator 203 may include a reference node 302 having a reference voltage (V_{ref}). V_{ref} may control an output voltage (Vₒ) at an output node 312 of regulator 203. Output node 312 and output voltage Vₒ may be configured to supply power to one or more load circuits. Due to the relationship between reference voltage V_{ref} and output voltage Vₒ, reference voltage V_{ref} may be selected to provide the appropriate output voltage Vₒ to drive the one or more load circuits.

In the present example, regulator 203 may include an operational amplifier (op amp) 304 coupled, at its non-inverting terminal, to reference node 302 and configured to drive output voltage Vₒ according to reference voltage V_{ref}. The non-inverting terminal of op amp 304 may be coupled to reference node 302 such that the voltage received at the non-inverting terminal of op amp 304 may be approximately equal to reference voltage V_{ref}. The inverting terminal of op amp 304 may be coupled to a resistor 313 having a resistance (R₃₁₃) and a regulating transistor 315 at a feedback node 308 having a feedback voltage V_{fb}. Due to the high impedance between the inverting and non-inverting terminals of op amp 304, the voltage at feedback node 308 (V_{fb}) may be approximately equal to the voltage at reference node 302 (V_{ref}).

The voltage at output node 312 (Vₒ) may be approximately equal to the amount of voltage drop across resistor 313 plus the voltage at feedback node 308 (V_{fb}). A regulating current I₀ may pass through resistor 313 from output node 312 to feedback node 308. The voltage drop across resistor 313 (V_{R313}) may be represented by Ohm's law and therefore may be represented by the following equation:

V_{R313}≈I₀R₃₁₃

Therefore, output voltage Vₒ may be represented by the following equation:

Vₒ≈V_{fb}+(I₀R₃₁₃)

As mentioned earlier, V_{fb} may be approximately equal to V_{ref} due to the characteristics of op amp 304. Thus, Vₒ may be represented by the following equation:

Vₒ≈V_{ref}+(I₀R₃₁₃)

Therefore, by approximately matching V_{fb} to V_{ref}, op amp 304 may drive Vₒ based at least in part on V_{ref}.

Additionally, the output of op amp 304 may be coupled to the gate of a pass transistor 310 at a gate node 306. Pass transistor 310 may comprise any suitable transistor driven by op amp 304 and configured to allow current to pass through it to supply regulating current I₀. In the example depicted in FIG. 3, pass transistor 310 may comprise an npn metal-oxide-semiconductor field-effect transistor (n-type MOSFET or NMOS). Pass transistor 310 may be configured such that current passing from its drain to its source may supply regulating current I₀. For example, the drain of pass transistor 310 may be coupled to a power supply node 314 having a supply voltage V_{dd} and the source of pass transistor 310 may be coupled to output node 312. Supply node 314 may be configured to provide power to one or more components of regulator 203. The amount of current passing through pass transistor 310 may be related to the voltage at the gate of pass transistor 310. As noted above, op amp 304 may be configured to drive the voltage at the gate of pass transistor 310. Accordingly, op amp 304 may be configured to drive regulating current I₀, from which Vₒ may depend.

Although the present example depicts pass transistor 310 as comprising an NMOS transistor configured with respect to op amp 304 and output node 312 in a particular manner, the present disclosure should not be limited to such. Any appropriate transistor and op amp configuration that may provide a current and generate an output voltage at an output node based on a reference voltage and current (e.g., regulating current I₀) may be used without departing from the scope of the present disclosure.

Returning back to FIG. 3, as mentioned above, the output voltage (Vₒ) of regulator 203 may be related to the amount of regulating current I₀ passing through resistor 313. Regulator 203 may be configured such that the amount of regulating current I₀ passing through resistor 313 is related to temperature. Therefore, regulator 203 may be configured to modify the output voltage Vₒ based at least in part on temperature by modifying regulating current I₀ based at least in part on temperature.

Regulator 203 may be configured to adjust regulating current I₀ according to temperature by modifying the amount of regulating current I₀ with a proportional to absolute temperature (PTAT) circuit 317. In the present embodiment, using a regulating transistor 315, regulator 203 may be configured such that regulating current I₀ mirrors a temperature dependent current generated by PTAT circuit 317.

Regulating transistor 315 may comprise an NMOS transistor 315 configured such that regulating current I₀ passes through regulating transistor 315 to ground. Accordingly, the drain of regulating transistor 315 may be coupled to feedback node 308 and the source of regulating transistor 315 may be coupled to ground. Regulating transistor 315 may also be configured to control the amount of regulating current I₀, and therefore, control Vₒ. Although, op amp 304 and transistor 310 may also control the amount of regulating current I₀, by being coupled to feedback node 308 and ground, regulating transistor 315 may be configured to complete the circuit carrying I₀ and, therefore, also control the amount of regulating current I₀.

In the present embodiment, the gate of regulating transistor 315 may be coupled to the drain of an NMOS intermediate transistor 318, included in PTAT circuit 317, at a gate node 316. The gate of intermediate transistor 318 may also be coupled to gate node 316 such that the current passing through regulating transistor 315 (I₀) follows or “mirrors” the current passing through intermediate transistor 318 (I₁)—such that transistors 315 and 318 may be configured as a “current mirror.” As described in further detail, transistor 318 of PTAT circuit may be configured such that current I₁ depends on temperature, accordingly, due to current I₀ “mirroring” current I₁, current I₀ may also be temperature dependent.

A “current mirror” may comprise any configuration wherein the current passing through one transistor is related to the current passing through another transistor. In a current mirror, the current passing through one transistor need not be equal to the current passing through the other transistor, but may be related to the current passing through the other transistor. The relationship between the current passing through the two transistors may be a function of the relationship between the channel width and length ratio of the two transistors. For example, in the present embodiment regulating transistor 315 may have a channel width and length ratio of (W/L)₃₁₅ and intermediate transistor 318 may have a channel width and length ratio of (W/L)₃₁₈. The relationship between regulating current I₀ (the current passing through regulating transistor 315) and intermediate current I₁ (the current passing through intermediate transistor 318) may be represented by the following equation:

$${I}_{0} \approx {I}_{1} \frac{{( W / L )}_{315}}{{( W / L )}_{318}}$$

In the present example (W/L)₃₁₅ may be approximately equal to (W/L)₃₁₈ such that I₀ may be approximately equal to I₁.

The gate of NMOS adjustment transistor 320 may be coupled to the gates of transistors 318 and 315 at gate node 316 also, such that adjustment transistor 320 and 318 also comprise a current mirror (the current relationship between transistors 318 and 320 will be described in further detail). Therefore, adjustment transistor 320 may be configured to drive intermediate current I₁ which may in turn drive the current of I₀, which may in turn drive output voltage Vₒ.

Transistors 318 and 320 may be biased at the weak inversion or sub-threshold region such that I₁ and I₂ are temperature dependent. For example, in the present embodiment, I₁ may be represented by the following equation:

$${I}_{1} \approx {I}_{1 , Q} exp [ \frac{( {V}_{gs} - {V}_{th} )}{{nV}_{T}} ]$$

I_{1,Q} may represent the drain current of intermediate transistor 318 when V_{gs} of intermediate transistor 318 is approximately equal to Vₜₕ of intermediate transistor 318. I_{1,Q} may be represented by the following equation:

I_{1,Q}≈I_{M}(W/L)₃₁₈

I_{M} may represent a drain current that is independent of the size of intermediate transistor 318. V_{gs} of intermediate transistor 318 may represent the voltage difference between the gate of intermediate transistor 318 and the source of intermediate transistor 318. In the present example, the source of intermediate transistor 318 may be coupled to ground and the gate may be coupled to gate node 316 having a voltage V_{G}, such that V_{gs} of intermediate transistor 318 may be approximately equal to V_{G}. Vₜₕ of intermediate transistor 318 may represent the threshold voltage of intermediate transistor 318.

V_{T} of intermediate transistor 318 may represent the thermal voltage of intermediate transistor 318 and n may represent a process dependent device parameter. V_{T} and n may together represent a sub-threshold slope (S) of a MOSFET. In the present example, S may approximately be between 70 mV-90 mV at 300° Kelvin (K). The sub-threshold slope may be expressed by the following equation:

S≈nVT.

V_{T} of intermediate transistor 318 may approximately represent the thermal voltage of intermediate transistor 318 and may be expressed by the following equation:

$${V}_{T} \approx \frac{kT}{q}$$

Therefore, the sub-threshold slope may be represented by the following equation:

$$S \approx {nV}_{T} \approx \frac{nkT}{q}$$

The Boltzman constant may be represented by k, electron charge may be represented by q and T may represent temperature. Therefore, I₁ may also be expressed by the following equation:

$${I}_{1} \approx {{I}_{M} ( W / L )}_{318} exp [ \frac{q ( {V}_{G} - {V}_{th} )}{nkT} ]$$

As mentioned above, adjustment transistor 320 may be biased in the weak inversion/sub-threshold region similar to intermediate transistor 318. Accordingly, the current passing through adjustment transistor 320 (I₂) may be represented by the following equation:

$${I}_{2} \approx {I}_{2 , Q} exp [ \frac{( {V}_{gs} - {V}_{th} )}{{nV}_{T}} ]$$

As mentioned earlier, V_{gs} of adjustment transistor 320 may represent the difference between the gate voltage (V_{g}) of adjustment transistor 320 and the source voltage (Vₛ) of adjustment transistor 320. The gate of adjustment transistor 320 may be coupled to gate node 316 having gate voltage V_{G}, such that the gate voltage (V_{g}) of adjustment transistor 320 is approximately equal to V_{G}.

The source of adjustment transistor 320 may also be coupled to a adjustment node 328 having an adjustment voltage (V_{A}), such that the source voltage (Vₛ) of adjustment transistor 320 is approximately equal to V_{A}. An adjustment resistor 327 having a resistance R₃₂₇, may also be coupled to adjustment node 328 and ground. Therefore, current passing through adjustment transistor 320 (I₂) may also pass through resistor 327 to ground. Accordingly, using Ohm's law, the voltage at adjustment node 328 (V_{A}) may be approximately equal to the voltage drop across resistor 327 (V_{R327}), as represented by the following equation:

V_{A}≈V_{R327}≈(I₂R₃₂₇)

Therefore, V_{gs} of adjustment transistor 320 may be represented by the following equation:

V_{gs}≈V_{G}−V_{A}≈V_{G}−(I₂R₃₂₇)

Additionally, I_{2,Q} may be represented by the following equation:

I_{2,Q}≈I_{M}(W/L)₃₂₀

Similar to V_{T} with respect to I₁, V_{T} with respect to I₂ may also be represented by the following equation:

$${V}_{T} \approx \frac{kT}{q}$$

Therefore, I₂ may be represented by the following equation:

$${I}_{2} \approx {{I}_{M} ( W / L )}_{320} exp [ \frac{q ( {V}_{G} - {I}_{2} {R}_{327} - {V}_{th} )}{nkT} ] \approx {{I}_{M} ( W / L )}_{320} \frac{exp [ \frac{q ( {V}_{G} - {V}_{th} )}{nkT} ]}{exp [ \frac{q ( {I}_{2} {R}_{327} )}{nkT} ]}$$

From the above equations approximating I₁ and I₂, the relationship between I₁ and I₂ may be represented by the following equation:

$$\frac{{I}_{1}}{{I}_{2}} \approx \frac{{( W / L )}_{318}}{{( W / L )}_{320}} exp [ \frac{q ( {I}_{2} {R}_{327} )}{nkT} ]$$

Additionally, in the present embodiment, the drain of intermediate transistor 318 may be coupled to the drain of a pnp MOSFET (PMOS) transistor 326. The source of transistor 326 may be coupled to supply node 314 having supply voltage V_{dd}, such that intermediate current I₁ may pass through transistor 326 before passing through intermediate transistor 318. Accordingly, transistor 326 may also influence intermediate current I₁. Similarly, the drain of adjustment transistor 320 may be coupled to the drain PMOS transistor 324. The source of transistor 324 may be coupled to supply node 314 having supply voltage V_{dd}, such that adjustment current I₂ may pass through transistor 324 before passing through adjustment transistor 320. Accordingly, transistor 324 may also influence adjustment current I₂.

Transistors 326 and 324 may be biased in the saturation region and may also comprise a current mirror. Therefore, the relationship between the current passing through transistor 326 (I₁) and the current passing through transistor 324 (I₂) may be related to the channel width to length ratio of transistors 326 and 324 and may be represented by the following equation:

$$\frac{{I}_{1}}{{I}_{2}} \approx \frac{{( W / L )}_{326}}{{( W / L )}_{324}}$$

In the present embodiment, (W/L)₃₂₆ may be approximately equal to (W/L)₃₂₄, therefore, I₁ may be approximately equal to I₂. With I₁ being approximately equal to I₂, the equation relating I₁ and I₂ with respect to transistors 318 and 320 may be represented by the following equation:

$$\frac{{I}_{1}}{{I}_{2}} \approx 1 \approx \frac{{( W / L )}_{318}}{{( W / L )}_{320}} exp [ \frac{q ( {I}_{2} {R}_{327} )}{nkT} ]$$

Therefore, by solving the above equation for I₂, I₂ may be represented by the following equation:

$${I}_{2} \approx \frac{nk}{{qR}_{327}} T ln [ \frac{{( W / L )}_{320}}{{( W / L )}_{318}} ]$$

As already noted, in the present embodiment, I₁ may be approximately equal to I₂, and I₀ may be related to I₁ based on the width to length ratio of transistors 318 and 315. In the present embodiment, the width to length ratios of transistors 318 and 315 may be approximately equal to each other such that I₀ may be approximately equal to I₁, and therefore, I₀ may be approximately equal to I₂. Accordingly, in the present embodiment, I₀ may be represented by the following equation:

$${I}_{0} \approx {I}_{2} \approx \frac{nk}{{qR}_{327}} T ln [ \frac{{( W / L )}_{320}}{{( W / L )}_{318}} ]$$

Additionally, as noted earlier, output voltage Vₒ may be a function of I₀, and therefore output voltage Vₒ may be represented by the following equation:

$${V}_{o} \approx {V}_{ref} + ( {I}_{0} {R}_{313} ) \approx {V}_{ref} + ( \frac{{R}_{313}}{{R}_{327}} \frac{nk}{q} T ln [ \frac{{( W / L )}_{320}}{{( W / L )}_{318}} ] )$$

Therefore, output voltage Vₒ of regulator 203 may be a function of temperature. From the above equation it can be seen that the amount of change in Vₒ based on the change in temperature—a temperature coefficient (T_{c}) of output voltage Vₒ—may be a function of the ratio between R₃₁₃ and R₃₂₇ (R₃₁₃/R₃₂₇), and the ratio between (W/L)₃₂₀ and (W/L)₃₁₈ ((W/L)₃₂₀/(W/L)₃₁₈). The temperature coefficient (T_{c}) of output voltage Vₒ may be expressed by the following equation:

$${T}_{c} \approx \frac{\partial {V}_{o}}{\partial T} \approx ( \frac{{R}_{313}}{{R}_{327}} \frac{nk}{q} ln [ \frac{{( W / L )}_{320}}{{( W / L )}_{318}} ] )$$

Accordingly, R₃₁₃, R₃₂₇, and (W/L)₃₂₀/(W/L)₃₁₈ may be adjusted during design of regulator 203 to achieve a desired temperature coefficient of output voltage Vₒ.

Additionally, by combining the equation for the temperature coefficient T_{c}, with the equation for the output voltage Vₒ, the output voltage Vₒ may be represented by the following equation:

$${V}_{o} \approx {V}_{ref} + ( {I}_{0} {R}_{313} ) \approx {V}_{ref} + ( \frac{{R}_{313}}{{R}_{327}} \frac{nk}{q} T ln [ \frac{{( W / L )}_{320}}{{( W / L )}_{318}} ] ) \approx {V}_{ref} + {TT}_{c}$$

Therefore, by the ratio between R₃₁₃ and R₃₂₇, modifying the ratio between (W/L)₃₂₀ and (W/L)₃₁₈, or both, the amount of change in Vₒ due to a change in temperature T may also be modified. Accordingly, regulator 203 may be designed to have the appropriate output voltage at the varying temperatures of regulator 203.

For example, regulator 203 may supply voltage to circuits that may require a voltage of approximately 1.5 volts at a higher temperature (e.g., approximately 363° K), approximately 1.4 volts at an ambient temperature (e.g., approximately 300° K) and approximately 1.3 volts at a lower temperature (e.g., approximately 233° K). Accordingly, the ratio between R₃₁₃ and R₃₂₇, the ratio between (W/L)₃₂₀ and (W/L)₃₁₈, or both, may be adjusted such that the output voltage Vₒ approximates these levels at these temperatures.

For example, V_{ref} may be approximately 1.1 volts, the sub-threshold slope (S) of transistors 318 and 320 may be approximately equal to seventy milli-volts (70 mV). Additionally, R₃₁₃ may be approximately equal to two hundred thirty kiloohms (230 kΩ) and R₃₂₇ may be approximately equal to one hundred kiloohms (100 kΩ). Also,

$$\frac{{( W / L )}_{320}}{{( W / L )}_{318}}$$

may be approximately equal to eight (8). As noted earlier the sub-threshold slope may be expressed by the following equation:

$$S \approx \frac{nkT}{q}$$

Therefore, in the present example of a threshold slope of approximately 70 mv at 300° K, (nk/q), in the equation approximating output voltage Vₒ, nk/q may be determined with the following equation:

$$\frac{nk}{q} \approx \frac{S}{T} \approx \frac{70 mV}{300 K} \approx 0.23 mV / ° K$$

Thus, in the present example, the temperature coefficient may be expressed by the following equation:

$${T}_{c} \approx ( \frac{{R}_{313}}{{R}_{327}} \frac{nk}{q} ln [ \frac{{( W / L )}_{320}}{{( W / L )}_{318}} ] ) \approx ( \frac{230 k Ω}{100 k Ω} ) * 0.23 mV / ° K * ln ( 8 ) \approx 1.1 mV / ° K$$

Accordingly, the output voltage Vₒ at an ambient temperature of 300° K may be represented by the following equation:

Vₒ≈V_{ref}+TT_{c}≈1.1V+300° K*1.1 mV/° K≈1.4V

Using the same equation, the output voltage Vₒ at a higher temperature of 363° K may be approximately equal to 1.5 V, and the output voltage Vₒ at a lower temperature of 233° K may be approximately equal to 1.3 V. Therefore, in the present example, the present embodiment may be configured such that the output voltage is a function of temperature and may also be configured such that the output voltage approximately achieves a desired voltage level for a particular temperature. Accordingly, by varying the output voltage Vₒ with the temperature, regulator 203 may consume less power and preserve more energy, thus adding benefits such as longer battery life in handheld devices.

Modifications, additions or omissions may be made to regulator 203 in FIG. 3 without departing from the scope of the present disclosure. For example, although a particular PTAT circuit has been described, any suitable PTAT circuit configured to alter the output voltage Vₒ of regulator 203 may be used. Additionally, the components of regulator 203, such as the transistors, have been described with respect to specific types and sizes of transistors, but any suitable transistor that may be used to perform the described functions may also be used.

FIG. 4 illustrates another example schematic of a regulator 203 configured to have a temperature dependent output voltage, in accordance with certain embodiments of the present disclosure. Regulator 203 may comprise a reference node 302 having a reference voltage V_{ref}, an op-amp 304, a pass transistor 310, an output node 312 having an output voltage Vₒ, a feedback node 308 and a resistor 313 coupled to output node 312 and feedback node 308, configured in a substantially similar manner as those described with respect to FIG. 3.

However, regulator 203 of FIG. 4 may also include a PTAT circuit 317 and a resistor 404 coupled to reference node 302, such that PTAT circuit 317 may modify V_{ref} according to temperature. Accordingly, as explained above, due to Vₒ being a function of V_{ref}, regulator 203 of FIG. 4 may modify Vₒ based at least in part on temperature. Regulator 203 of FIG. 4 may also include a resistor 402 coupled to feedback node 308 and ground such that the current passing from output node 312 to ground through resistors 313 and 402 may not be a function of temperature. Therefore, regulator 203 of FIG. 4 may be configured to vary Vₒ according to temperature by varying V_{ref} according to temperature instead of varying Vₒ according to temperature by varying the current passing through resistor 313 according to temperature as described with respect to FIG. 3.

In the present example, PTAT circuit 317 may be configured to output a temperature dependent reference current I_{ref} such that I_{ref} may pass through resistor 404, having a resistance R₄₀₄, to ground. Due to Ohm's law, reference voltage V_{ref} may be a function of I_{ref} and R₄₀₄. Therefore, due to the temperature dependency of I_{ref}, V_{ref} may also be temperature dependent.

In the present embodiment, the temperature coefficient of the present embodiment may be a function of the resistive value of resistor 404 and the resistive values of one or more resistors included in PTAT circuit 317. Additionally, the temperature coefficient may be a function of channel width to length ratios of transistors included in PTAT circuit 317. Therefore, the appropriate temperature coefficient to achieve the desired voltage at various temperature levels may be achieved by configuring one or more of these components.

Modifications, additions or omissions may be made to FIG. 4 without departing from the scope of the present disclosure. For example, the configuration of PTAT circuit 317 with respect to reference node 302 may be any suitable configuration such that V_{ref} is a function of the temperature dependent current I_{ref}, and as such, the disclosure should not be limited to the present configuration.

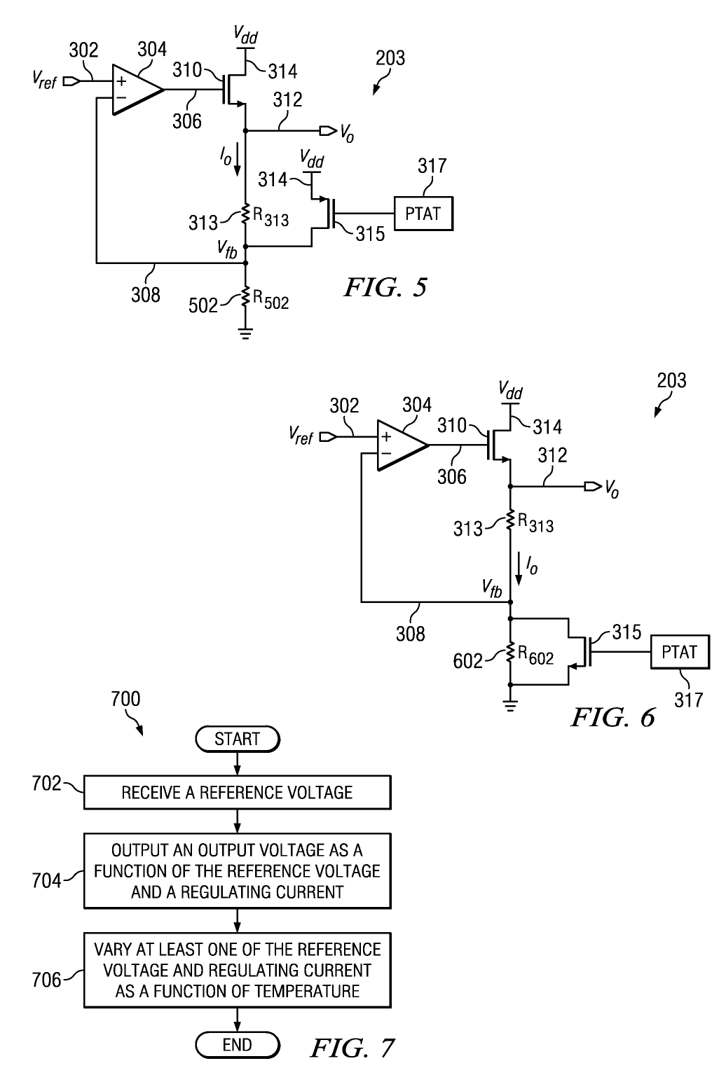

FIG. 5 illustrates a further example schematic of a regulator configured to have a temperature dependent output voltage, in accordance with certain embodiments of the present disclosure. Regulator 203 of FIG. 5 may comprise a reference node 302 having a reference voltage V_{ref}, an op-amp 304, a pass transistor 310, an output node 312 having an output voltage Vₒ, a feedback node 308 and a resistor 313 coupled to output node 312 and feedback node 308, configured in a substantially similar manner as those described with respect to FIG. 3. Additionally, similar to in FIG. 3, regulator 203 of FIG. 5 may include a transistor 315 coupled to a PTAT circuit 317 such that the current flowing through transistor 315 mirrors the temperature dependent current of PTAT circuit.

However, unlike in FIG. 3, transistor 315 may be coupled to supply node 314 and feedback node 308, such that current flows through transistor 315 from supply node 314 to feedback node 308. Further, transistor 315 may comprise a PMOS transistor instead of an NMOS transistor. Additionally, in the present embodiment, regulator 203 may include a resistor 502 having a resistance R₅₀₂ coupled to feedback node 308 and ground.

Further, unlike in FIG. 3, in the present configuration, the temperature coefficient may be negative such that Vₒ decreases due to an increase in temperature and increases due to a decrease in temperature. As mentioned above with respect to FIG. 3, Vₒ may be a function of the regulating current I₀ passing through resistor 313 and the voltage at feedback node 308 (V_{fb}). Additionally, due to the characteristics of op amp 304, V_{fb} may be maintained at approximately the same voltage as V_{ref}—in some instances V_{fb} may change while op amp 304 is responding to loads being applied or removed at output node 312, but typically V_{fb} may be relatively constant. Therefore, due to Ohm's law the current passing through resistor 502 may also be relatively constant. In the current configuration, PTAT circuit 317 may be configured to increase its output current as the temperature increases, such that the current passing through transistor 315 may also increase. Based on Kirchhoff's current law with respect to feedback node 308, due to the current passing through resistor 502 remaining relatively steady, as the current passing through transistor 315 increases, the current passing through resistor 313 may decrease. Therefore, based on Ohm's law, the voltage across resistor 313 may decrease, which may cause Vₒ to decrease. Accordingly, as the temperature increases, Vₒ may decrease and vice versa.

In the present embodiment, the temperature coefficient of the present embodiment may be a function of the resistive values of resistor 313 and resistor 502 (R₃₁₃ and R₅₀₂). Additionally, the temperature coefficient may be a function of the resistive values of one or more resistors and channel width to length ratios of transistors included in PTAT circuit 317. Therefore, the appropriate temperature coefficient to achieve the desired voltage at various temperature levels may be achieved by configuring one or more of these components.

Modifications, additions or omissions may be made to FIG. 5 without departing from the scope of the present disclosure. For example, the configuration of PTAT circuit 317 with respect to output node 312 may be any suitable configuration such that Vₒ decreases with an increase in temperature and increases as a function of temperature, and as such, the disclosure should not be limited to the present configuration.

FIG. 6 illustrates an additional example schematic of a regulator configured to have a temperature dependent output voltage, in accordance with certain embodiments of the present disclosure. Regulator 203 of FIG. 6 may comprise a reference node 302 having a reference voltage V_{ref}, an op-amp 304, a pass transistor 310, an output node 312 having an output voltage Vₒ, a feedback node 308 and a resistor 313 coupled to output node 312 and feedback node 308, configured in a substantially similar manner as those described with respect to FIG. 3. Additionally, similar to in FIG. 3, regulator 203 of FIG. 6 may include a transistor 315 coupled to a PTAT circuit 317 such that the current flowing through transistor 315 mirrors the temperature dependent current of PTAT circuit. Further, transistor 315 may be coupled to feedback node 308 and ground similarly to the configuration of FIG. 3.

However, unlike in FIG. 3, regulator 203 may also include a resistor 602 coupled to feedback node 308 and ground such that resistor 602 is electrically parallel to transistor 315. PTAT circuit 317 and transistor 315 may be similarly configured such that as the temperature increases, the current passing through transistor 315 increases. Additionally, due to Ohm's law and Kirchhoff s current law, as the current passing through transistor 315 increases, a regulating current I₀ passing through resistor 313 may increase, causing Vₒ to increase. Therefore, regulator 203 of FIG. 6 may function similarly to regulator 203 of FIG. 3. However the temperature coefficient in FIG. 6 may also be a function of the resistance R₆₀₂ of resistor 602.

In addition to being a function of the resistive value of resistor 602 (R₆₀₂), the temperature coefficient of the present embodiment may be a function of the resistive values of resistor 313 and the resistive values of one or more resistors and channel width to length ratios of transistors included in PTAT circuit 317. Therefore, the appropriate temperature coefficient to achieve the desired voltage at various temperature levels may be achieved by configuring one or more of these components.

Modifications, additions or omissions may be made to FIG. 6 without departing from the scope of the present disclosure. For example, the configuration of PTAT circuit 317 with respect to output node 312 may be any suitable configuration such that Vₒ is a function of the temperature dependent current I₀, and as such, the disclosure should not be limited to the present configuration.

Additionally, although specific configurations of varying the output voltage of a voltage regulator with a PTAT circuit have been disclosed with respect to FIGS. 3-6, the present disclosure should not be limited to such. Any suitable configuration where a PTAT circuit may modify voltages or currents as a function of temperature such that the output voltage of a voltage regulator is a function of temperature may be contemplated. Additionally, one or more of the disclosed configurations may be combined. For example, a voltage regulator may include a PTAT circuit configured to vary the reference voltage as a function of temperature and also a PTAT circuit configured to vary the regulating current as a function of temperature.

FIG. 7 illustrates an example method 700 for regulating the output voltage of a voltage regulator based on temperature. Method 700 may begin at step 702 where a voltage regulator may receive a reference voltage at an input node (e.g., regulator 203 receiving reference voltage V_{ref}, at reference node 302).

At step 704 the voltage regulator may output an output voltage as a function of the reference voltage and a regulating current passing through a resistor coupled to the output node (e.g., output voltage Vₒ of regulator 203 may be a function of V_{ref} and I₀).

At step 706, a PTAT circuit coupled to the voltage regulator may vary at least one of the reference voltage and the regulating current partially based on the temperature. For example, a PTAT circuit may vary the reference voltage as a function of temperature similar to that described with respect to FIG. 4. In the same or another embodiment, a PTAT circuit may vary the regulating current as function of temperature similar to that described with respect to FIGS. 3, 5 and 6. Accordingly, due to the output voltage being a function of the regulating current and the reference voltage, and the regulating current and reference voltage being a function of the temperature, the PTAT circuit of the voltage regulator may adjust the output voltage based at least in part on temperature. Following step 706, method 700 may end. Modifications, additions or omissions may be made to method 700 without departing from the scope of the present disclosure. For example, the regulating current may be a function of an intermediate current which may be a function of the adjustment current, but this step has not been explicitly mentioned in method 700. Although the present disclosure and its advantages have been described in detail, it should be understood that various changes, substitutions and alterations can be made herein without departing from the spirit and scope of the disclosure as defined by the following claims.

What is claimed is:

1. A voltage regulator comprising:
an input node configured to receive a reference voltage;
an output node configured to output an output voltage, the output voltage is a function of the reference voltage and a regulating current; and
a proportional to absolute temperature (PTAT) circuit coupled to at least one of the output node and the input node and configured to vary at least one of the reference voltage and the regulating current as a function of temperature.

2. The regulator of claim 1, the PTAT circuit coupled to at least one of the output node and the input node such that as temperature increases at least one of the reference voltage and the regulating current increases and as temperature decreases at least one of the reference voltage and the regulating current decreases.

3. The regulator of claim 1, the PTAT circuit coupled to at least one of the output node and the input node such that as temperature increases at least one of the reference voltage and the regulating current decreases and as temperature decreases at least one of the reference voltage and the regulating current increases.

4. The regulator of claim 1, further comprising:
a feedback node;
a first resistor coupled to the output node and the feedback node such that the regulating current passes through the first resistor from the output node to the feedback node; and
a transistor coupled to the feedback node and ground such that the regulating current passes through the transistor, the transistor further coupled to the PTAT circuit such that the PTAT circuit is coupled to the output node via the transistor and the first resistor and such that the regulating current is a function of a temperature coefficient, the temperature coefficient a function of a second resistor of the PTAT circuit and the first resistor.

5. The regulator of claim 4, further comprising a third resistor coupled to the feedback node and ground in parallel with the transistor, the temperature coefficient also a function of the third transistor.

6. The regulator of claim 1, further comprising:
a feedback node;
a power supply node;
a first resistor coupled to the output node and the feedback node such that the regulating current passes through the first resistor from the output node to the feedback node;
a second resistor coupled to the feedback node and ground; and
a transistor coupled to the power supply node and the feedback node, the transistor further coupled to the PTAT circuit such that the PTAT circuit is coupled to the output node via the transistor and the first resistor and such that the regulating current is a function of a temperature coefficient, the temperature coefficient a function of the first resistor and the second resistor.

7. The regulator of claim 1, further comprising a resistor coupled to the input node and ground, the PTAT circuit coupled to the input node such that a temperature dependent reference current passes from the PTAT circuit to ground through the resistor, the reference voltage a function of the reference current and the resistor.

8. The regulator of claim 1, the PTAT circuit including a current mirror comprising a first transistor and a second transistor, the PTAT circuit configured to vary at least one of the reference voltage and regulating current as a function of a first channel width to length ratio of the first transistor and a second channel width to length ratio of the second transistor.

9. A wireless communication element, comprising:
a receive path configured to receive a first wireless communication signal and convert the first wireless communication signal into a first digital signal;
a transmit path configured to convert a second digital signal into a second wireless communication signal and transmit the second wireless communication signal; and
a voltage regulator comprising:
an input node configured to receive a reference voltage;
an output node configured to output an output voltage, the output voltage is a function of the reference voltage and a regulating current; and
a proportional to absolute temperature (PTAT) circuit coupled to at least one of the output node and the input node and configured to vary at least one of the reference voltage and the regulating current as a function of temperature.

10. The communication element of claim 9, the PTAT circuit coupled to at least one of the output node and the input node such that as temperature increases at least one of the reference voltage and the regulating current increases and as temperature decreases at least one of the reference voltage and the regulating current decreases.

11. The communication element of claim 9, the PTAT circuit coupled to at least one of the output node and the input node such that as temperature increases at least one of the reference voltage and the regulating current decreases and as temperature decreases at least one of the reference voltage and the regulating current increases.

12. The communication element of claim 9, the regulator further comprising:
a feedback node;
a first resistor coupled to the output node and the feedback node such that the regulating current passes through the first resistor from the output node to the feedback node; and
a transistor coupled to the feedback node and ground such that the regulating current passes through the transistor, the transistor further coupled to the PTAT circuit such that the PTAT circuit is coupled to the output node via the transistor and the first resistor and such that the regulating current is a function of a temperature coefficient, the temperature coefficient a function of a second resistor of the PTAT circuit and the first resistor.

13. The communication element of claim 12, the regulator further comprising a third resistor coupled to the feedback node and ground in parallel with the transistor, the temperature coefficient also a function of the third transistor.

14. The communication element of claim 9, the regulator further comprising:
a feedback node;
a power supply node;
a first resistor coupled to the output node and the feedback node such that the regulating current passes through the first resistor from the output node to the feedback node;
a second resistor coupled to the feedback node and ground; and
a transistor coupled to the power supply node and feedback node, the transistor further coupled to the PTAT circuit such that the PTAT circuit is coupled to the output node via the transistor and the first resistor and such that the regulating current is a function of a temperature coefficient, the temperature coefficient a function of the first resistor and the second resistor.

15. The communication element of claim 9, the regulator further comprising a resistor coupled to the input node and ground, the PTAT circuit coupled to the input node such that a temperature dependent reference current passes from the PTAT circuit to ground through the resistor, the reference voltage a function of the reference current and the resistor.

16. The communication element of claim 9, the PTAT circuit including a current mirror comprising a first transistor and a second transistor, the PTAT circuit configured to vary at least one of the reference voltage and regulating current as a function of a first channel width to length ratio of the first transistor and a second channel width to length ratio of the second transistor.

17. A method comprising:
receiving, by a voltage regulator, a reference voltage at an input node;
outputting, by the voltage regulator, an output voltage that is a function of the reference voltage and a regulating current; and
varying, by a proportional to absolute temperature (PTAT) circuit, at least one of the reference voltage and the regulating current as a function of temperature, the PTAT circuit coupled to at least one of the output node and the input node.

18. The method of claim 17, further comprising increasing at least one of the reference voltage and the regulating current as temperature increases and decreasing at least one of the reference voltage and the regulating current as temperature decreases.

19. The method of claim 17, further comprising increasing at least one of the reference voltage and the regulating current as temperature decreases and decreasing at least one of the reference voltage and the regulating current as temperature increases.

20. The method of claim 17, further comprising varying the regulating current as a function of a temperature coefficient, the regulating current passing from the output node to a feedback node of the regulator through a first resistor coupled to the output node and the feedback node, the regulating current also passing from the feedback node to ground through a transistor coupled to the feedback node and ground, the transistor further coupled to the PTAT circuit such that the PTAT circuit is coupled to the output node via the transistor and the first resistor and such that the temperature coefficient is a function of a second resistor of the PTAT circuit and the first resistor.

21. The method of claim 20, the temperature coefficient further a function of a third resistor coupled to the feedback node and ground in parallel with the transistor.

22. The method of claim 17, further comprising varying the regulating current as a function of a temperature coefficient, the regulating current passing from the output node to a feedback node of the regulator through a first resistor coupled to the output node and the feedback node, the regulating current controlled at least in part by a transistor coupled to a power supply node of the regulator and the feedback node and further coupled to the PTAT circuit such that the PTAT circuit is coupled to the output node via the transistor and the first resistor and such that the temperature coefficient is a function of the first resistor and a second resistor coupled to the feedback node and ground.

23. The method of claim 17, further comprising varying the reference voltage as a function of a reference current and a resistor, the reference current passing from the PTAT circuit to the input node and from the input node to ground through the resistor.

24. The method of claim 17, further comprising varying at least one of the reference voltage and the regulating current as a function of a first channel width to length ratio of a first transistor of the PTAT circuit and a second channel width to length ratio of a second transistor of the PTAT circuit.
